(19) United States
(12) Patent Application Publication
(10) Pub. No.: US 2010/0285321 A1
(43) Pub. Date: Nov. 11, 2010

(54) HYDROPHILIC HARDCOAT COATINGS

(75) Inventor: Karlheinz Hildenbrand, Krefeld (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/668,978

(22) PCT Filed: Jul. 3, 2008
(86) PCT No.: PCT/EP2008/005412

§ 371 Date: Jan. 13, 2010

(30) Foreign Application Priority Data
Jul. 14, 2007 (DE) 10 2007 032 886.0

(51) Int. Cl. C09D 133/08; B05D 3/06; B32B 27/06; B32B 27/10; B32B 17/10

(52) U.S. Cl. 428/442; 522/182; 427/515; 428/522; 428/514

(57) ABSTRACT

The invention relates to a composition comprising a) colloidal silica; b) acrylate; c) protic solvent; d) UV initiator system; and e) singly charged anionic, sulfur-containing surfactant, to the use of the composition to coat substrates, and to substrates coated with formulas of this kind.

The invention relates to a composition comprising a) colloidal silica; b) acrylate; c) protic solvent; d) UV initiator system; and e) singly charged anionic, sulfur-containing surfactant, to the use of the composition to coat substrates, and to substrates coated with formulas of this kind.

The surface of UV-crosslinked hardcoat coatings, in comparison to conventional acrylate systems, is hydrophilic and SiOH functional and hence constitutes an ideal surface for further coatings, more particularly for cationic agents from aqueous solution.

Improving the properties of coatings through integration of silica has already been known for some considerable time as a principle. Through admixture of silica particles in such cases, coatings can be enhanced in terms, for example, of abrasion, scratch resistance, reflection properties, gloss, antistatic properties, flammability, UV resistance, nonfoggability with water vapor (“antifog” properties), wettability with water, and chemical resistance. Where silica is used in the form of nanoparticles (particle sizes smaller than 100 nm), it ought in principle to be possible to obtain these enhancements of properties with at the same time retention, or only minor attenuation, of the transparency.

Thus in the past there has been no lack of attempts to provide coating compositions containing silicon dioxide with overall properties improved further in respect of the above features.

DE 103 11 639 A1 describes antistatically treated shaped bodies and a process for producing them. To solve the problem a description is given in that context of coating systems comprising acrylate-containing binders, alcoholic solvents, nanoscale electrically conductive metal oxides, nanoscale inert particles such as silicon dioxide, and, optionally, further additives such as, for example, dispersing assistants. The average particle size of the inert nanoparticles used is 2 nm to 100 nm, and they are used in amounts of 0.1% by mass to 50% by mass, based on the dry film.

JP 61-181809 discloses UV-curable compositions for coatings having good adhesion properties and also high abrasion resistance, comprising α,β-unsaturated carboxylic acids, and colloidal particles of silicon dioxide, in dispersion in water or lower alcohols.

JP 2005-179539 describes “antifog” coatings composed of 20% to 99% by weight of a mixture which is composed of 0% to 80% by weight of fine-scale particles, silicon dioxide for example, and 100% to 20% by weight of a plastic, and also of 0.5% to 30% by weight of a sulfosuccinate having two anionic substituents.

Film-forming compositions based on polyfunctional acrylic esters for the production of coatings of high transparency, weathering stability, and scratch resistance are described in EP 0 050 996. In addition to the stated acrylic acid derivatives, the compositions comprise a polymerization initiator and also inorganic fillers such as, for example, silicon dioxide, with average particle diameters of between 1 nm and 1 μm and also with a refractive index of 1.40 to 1.60.

U.S. Pat. No. 4,499,217 describes water-free, film-forming compositions composed of colloidal silicon dioxide with average particle diameters of 10 μm to 50 μm, and thermosetting compounds, acrylic compounds for example. The cured coatings exhibit good abrasion resistance and good adhesion to substrates.

JP 2001-019874 discloses compositions comprising (poly)ethylene glycol (poly)methyl methacrylate, acrylamides, photoinitiators, dispersing assistants, and silica for producing coatings having high adhesion and increased scratch resistance.

WO 2006049008 describes a hydrophilic coating based on silica particles which are suspended in a high-boiling solvent, such as N,N-dimethylacetamide, are admixed with an alcoholic solution of a nonionic surfactant (L-77), and then are heat-treated at 100° C. for 10 minutes. The coating leads to a hydrophilic surface, with water contact angles of 20° or smaller being achievable. This method is employed for the coating of spectacle lenses with respect to antifog properties. In contrast, these conditions are unsuitable for coatings on plastics substrates, on account of their sensitivity to the solvents that are used here.

A casting formula consisting of a mixture of an organic solution of polyvinylbutyral and an alcoholic suspension of colloidal silica is described in U.S. Pat. No. 4,383,057. In terms of dry mass, the composition may be composed of 20% to 95% by weight of polyvinylbutyral and 80% to 5% by weight of silica. With a view to improving the stability values, such as scratch resistance, chemical resistance, and flammability, the polyvinylbutyral polymer is crosslinked, using, for example, methylolmelamines modified with alkyl ethers. No further details are given concerning surface properties, such as hydrophilicity or water contact angle. Moreover, although these coatings are described as being transparent, there are no quantitative data, such as haze values.

Langmuir, 6048-6053 Vol. 21, 2005 describes the production of transparent silicon dioxide/polymethyl methacrylate nanocomposites by means of the polymerization of microemulsions with the addition of dispersing assistants. Also disclosed in this context is the use of sodium bis(2-ethylhexyl)sulfosuccinate as an ionic surfactant. It has been found, however, that this surfactant, like all other ionic dispersing assistants used, leads in this case, after polymerization, to a loss of the transparency of the resulting nanocomposites.

If, as described in WO 2006048277, the intention is to generate surfaces having particularly high and dense silica structures, then the deposition of silica is frequently local, by flame hydrolysis from silica precursors, as for example from hexamethyldisilazane or tetraethoxysilane. Integrating fluoroalkylsilanes allows the hydrophobic character of these coatings to be reinforced.

EP-A 337 695 discloses silicon dioxide dispersions for the abrasion-resistant coating of solid substrates, especially transparent substrates. The dispersions comprise colloidal silicon dioxide with particle sizes less than 100 nm, preferably less than 75 nm, more preferably less than 50 nm, in dispersion in a protically substituted ester or amide of an acrylic or methacrylic acid. In this case, 0.1 to 2.5 parts by weight of silicon dioxide are used per part by weight of unsaturated monomer employed. Following addition of a photoinitiator, the dispersions can be cured on suitable substrates by UV radiation.

As described in examples 2-4 of EP-A337 695, the abrasion (abrasion test with Taber Abraser Model 503) of acrylate formulas can be enhanced through addition of silica nanoparticles. Whereas, in the case of unfilled acrylate systems (100% PETA/0% silica), a % haze value of 23.1 was found after 1000 cycles, the values are 18 in the case of the 66.6% FETA/33.3% silica ratio and 8.1 in the case of 50%/50% PETA/silica. At higher silica contents, however, there is a marked deterioration in the abrasion value. Thus, in the case of an arylate/(PETA)/silica ratio of 33.3/66.6, an abrasion value of 10.1 (% haze after 1000 cycles) was found. Accordingly, in the context of EP 337 695, the best product properties were obtained for the acrylate/silica ratio of approximately 1:1. Higher silica contents without deterioration in the abrasion values, however, would be of great interest in respect of the target objectives, namely hydrophilic hardcoat coatings with high affinities for aqueous cationic agents.

It is an object of the present invention, therefore, to provide hydrophilic hardcoat systems which have very good abrasion values in conjunction with low haze and adhere very well to a variety of substrates, The haze, determined by the haze values according to ASTM 1003-00, are to be less than 1%, preferably less than 0.6%. The abrasion values, determined in accordance with ASTM 1003-00, are to be less than 12% after 1000 cycles, preferably less than 8%. The adhesion, determined in accordance with ASTM D 3359, is to have ISO indexes of less than 2, preferably less than 1.

In particular for hardcoat coatings having hydrophilic surface properties and exhibiting the pattern of properties in accordance with the object, there continues to exist, in relation to the prior art, a heightened demand for the provision of suitable formulas which have a silica content which is well above the acrylate content employed.

Furthermore, these surfaces are to be useful as a primer layer for further coatings, more particularly from aqueous solutions which contain, for example, cationic agents.

The formulas according to the invention are to be capable of application to the respective substrates by means of simple technologies, such as dipping, spraying or flow coating.

It has surprisingly been found that formulas of this kind can be prepared from silica-containing UV-crosslinkable acrylate systems in combination with at least one anionic, sulfur-containing surfactant.

The present invention accordingly provides a composition comprising

a) colloidal silica;
b) acrylate;
c) protic solvent;
d) UV initiator system; (also termed photoinitiator); and
e) anionic, sulfur-containing surfactant.

It has surprisingly been found that the compositions of the invention enable very good product properties in the coated product.

Component a), colloidal silica, generally comprises protonated, alcohol-compatible silicon dioxide nanoparticles or silica nanoparticles with an acidic pH. More particularly the particles are spherical SiO₂ particles with diameters of 1 nm up to about 100 nm, with the particles used preferably being those having sizes of less than 50 nm, more preferably of less than 30 inn.

Products of this kind are produced by numerous manufacturers in different media. Very readily accessible are the corresponding aqueous, alkali stabilized nanoparticle suspensions, which are sold under the product names Levasil®, Ludox® or Nalco®, for example. The purely aqueous, alkali stabilized products, however, which in general have pH values of 9 to 10, are not suitable for the coating formulas of the invention. To start with, the aqueous suspensions are incompatible with the organically based binder systems described above; moreover, at the high pH levels, the photoreactive monomer esters would be hydrolytically degraded.

There are, however, known methods by which these aqueous nanoparticle suspensions can be converted into organically based, alkali free, alcohol compatible nanoparticle suspensions. For example, in accordance with EP 00569813, as described in more detail in Ex. 1, the aqueous nanoparticle suspensions are converted with the aid of cation exchangers (H form) into their protonated, alkali free form.

The corresponding, SiOH modified silica nanoparticle suspensions are compatible with protic solvents, such as alcohols, examples being isopropanol (IPA), 1-methoxy-2-propanol (MOP), n-propylglycol, n-butylglycol, propylene glycol or diacetone alcohol (DAA). From the alcohol/water mixtures the water fraction can then be removed in whole or in part by distillation or by solvent exchange by means of ultrafiltration.

More recently, protonated silica nanoparticles in dispersion in protic solvents, of this kind, have also been offered by numerous companies, in different particle sizes and different solvents. For example, the company Nissan under the product name Organosilikasol®, makes silica nanoparticles available commercially with particle sizes of 10 to 50 nm in ethylene glycol (EU), isopropanol (IPA) or methyl ethyl ketone (MEK). The product type used with particular preference, acquired from Nissan under the name Organosilikasol® IPA ST, has the following property features: the particle sizes are in the range of 10-15 nm, the SiO₂ solids content is 30-31% by weight, the water content is specified as being <1%, the viscosity is <15 mPa·s, and the pH is in the range of 2-4.

Specifically for UV and also electron beam curing systems, under the product name HILINK® Nano G, the company Clariant offers silica nanoparticles in mono-, di-, and trifunctional acrylates, such as 2-hydroxyethyl methacrylate, hexanediol diacrylate (HDDA), and trimethylolpropane triacrylate (TMPTA). The same company also offers nanosilica in alcohols, as for example in isopropanol or propylglycol, under the product name HILINK® G 502.

Under the name Nalco 1034A, the company NALCO also offers acidically (pH 2.8) formulated silica particles in alcohol/water mixtures.

In accordance with the selection criteria stated above, the formulas of the invention comprise high fractions of silica nanoparticles, the term “high” referring to the ratio of binder (acrylate system)/silica nanoparticles. In the coating-material surfaces of the invention, this ratio is set such that, as a result of concentration, the hydrophilic nanoparticles are also detectable at the coating-material surface, so producing an increased hydrophilicity relative to the pure binder. The corresponding hydrophilicity can easily be detected by application of a water drop. Whereas, in the case of coating materials comprising the pure acrylate system, the contact angle of the water drop is typically very steep, in the range of about 75-90°, for example, the water contact angles achieved in the case of the hydrophilic, silica nanoparticle containing coating-material surfaces of the invention are flatter, achieving values below 45°, preferably below 30°.

The binder/silica ratio is of course dependent on the particle size, and on the specific surface area of the nanoparticles. For example, in the case of the Nissan silica dispersion “Silika IPA ST” used with particular preference (particle size: 10-15 nm), the acrylate/silica ratio ought preferably to be set such that the silica content is higher than the acrylate binder content. Preferably the arylate/silica ratio is in the region from 45:55 up to a region of 25:75, more preferably in the region from 40:60 up to a region of 30:70.

It is also possible to mix mixtures of silica nanoparticles, as for example the finely divided Nissan particles IPA-ST (10-15 nm), with the coarser particles IPA-MS (17-23 nm) or IPA-ST L (40-50 nm).

Component b), acrylate, generally comprises UV or electron beam crosslinkable, ethylenically unsaturated monomers having aliphatic or cycloaliphatic radicals. Particular preference is given to low molecular mass acrylates and methacrylates having preferably less than 30 C atoms. Examples are hexanediol diacrylate (HDDA), dipentaerythritol hexaacrylate (DPHA), tripropylene glycol diaerylate (TPGDA), pentaerythritol triacrylate (PETA), pentaerythritol tetraaciylate, neopentylglycol diacrylate, hydroxyethyl acrylate, hydroxyethyl methacrylate (HEMA), glycidyl acrylates and methacrylates, and also functional silanes, such as 3-meth-acryloyloxypropyltrimethoxysilane. Mixtures of these acrylates can also be used.

As described in the examples, it is preferred to use polyfunctional acrylates, more preferably dipentaerythritol hexaacrylate (DPHA), or DPHA in a mixture with pentaerythritol triacrylate (PETA).

Component c), protic solvent, comprises protic solvents such as aliphatic alcohols such as, for example, ethanol, isopropanol, n-butanol, ethylene glycol, diethylene glycol, propylene glycol, ethoxyethanol, diacetone alcohol (DAA, 4-hydroxy-4-methyl-2-pentanone), 1-methoxy-2-propanol (MOP), n-propylglycol, n-butylglycol, and mixtures of these solvents.

These solvents are generally evaporated off after the operation of coating onto the substrate, before UV crosslinking takes place.

Further solvents which may be admixed to the end formula in small amounts are esters or ketones, such as ethyl acetate, butyl acetate, propoxyethyl acetate, methyl ethyl ketone, or methyl isobutyl ketone.

Component d), UV initiator system, comprises systems which, in air or under inert gas, initiate the polymerization of the acrylate components when UV light is irradiated. Systems of this kind, added typically in a few % by weight (about 2 to 10) in relation to the amount of acrylate employed, are available, for example, under the product names “Irgacure®, or Darocure®. Use is frequently also made of mixtures, such as Irgacure 184/Darocure TPO, for example. Here, Irgacure 184® is hydroxycyclohexyl phenyl ketone, and Darocure TPO® is diphenyl(2,4,6-trimethylbenzoyl)phosphine oxide).

Component e), anionic, sulfur-containing surfactant, comprises more particularly dioctylsulfosuccinate sodium salt (DSSNa), CAS No. [577-11-7], which is available in a number of versions from the company Cytec, USA, for example, under the product name Aerosol OT (AOT). The pure substance carries the designation Aerosol OT 100, whereas various formulations, in different solvents, of the same chemical species are available under the designations OT-75, OT-70-PG, OT 75-PG, OT-B, GPG, OT-S, and OT-TG. The pure substance is referred to below as DSSNa. The surfactant is used here in mass fractions of more than 0.025%, based on the overall coating-material solution, preferably in fractions between 0.05% and 0.09%, more preferably between 0.1% and 0.3%, in each case based on the coating-material solution as a whole. Surprisingly it has not been possible to obtain the desired effects using nonionic surfactants, such as Triton X 100, Span 80, Brij 35 or Pluronic L 64.

With regard to the substrates which can be further enhanced by the application of the coating formulas of the invention there is, within the context of the present invention, a broad possibility for selection of transparent, translucent, and even nontransparent materials such as ceramic, marble or wood. On account of the excellent “transparent protective properties” of the innovative coating systems, substrates, naturally, of high transparency are preferred. Very particular preference in this context is given to transparent thermoplastic polymers made, for example, of polycarbonate (Makrolon®, Apec®) or polycarbonate blends (Makroblend®, Bayblend®), polymethyl methacrylate (Plexiglas®), polyesters, cycloaliphatic olefins, such as Zeonor®, and glass.

Polycarbonates for the compositions of the invention are homopolycarbonates, copolycarbonates, and thermoplastic polyester carbonates.

The polycarbonates and copolycarbonates of the invention have in general average molecular weights (weight average) of 2 000 to 200 000, preferably 3 000 to 150 000, more particularly 5 000 to 100 000, very preferably 8 000 to 80 000, in particular 12 000 to 70 000 (determined by GPC with polycarbonate calibration).

On the preparation of polycarbonates for the composition of the invention, reference may be made, for example, to “Schnell”, Chemistry and Physics of Polycarbonates, Polymer Reviews, Vol. 9, Interscience Publishers, New York, London, Sydney 1964, to D.C. PREVORSEK, B. T. DEBONA and Y. KESTEN, Corporate Research Center, Allied Chemical Corporation, Morristown, N.J. 07960, “Synthesis of poly(ester)carbonate copolymers” in Journal of Polymer Science, Polymer Chemistry Edition, Vol. 19, 75-90 (1980), to D. Freitag, U. Grigo, Müller, N. Nouvertne, BAYER AG, “Polycarbonates” in Encyclopedia of Polymer Science and Engineering, Vol. 11, Second Edition, 1988, pages 648-718, and, finally, to Dres. U. Grigo, K. Kircher and P. R. Müller “Polycarbonate” in Becker/Braun, Kunststoff-Handbuch, Volume 3/1, Polycarbonate, Polyacetale, Polyester, Celluloseester, Carl Hanser Verlag Munich, Vienna 1992, pages 117-299. Preparation takes place preferably by the phase interface process or the melt transesterification process.

Preference is given to homopolycarbonates based on bisphenol A and to copolycarbonates based on the monomers bisphenol A and 1,1-bis(4-hydroxyphenyl)-3,3,5-trimethylcyclohexane. These or other suitable bisphenol compounds are reacted with carbon acid compounds, more particularly phosgene or, in the case of the metal transesterification process, diphenyl carbonate and/or dimethyl carbonate, to form the respective polymers.

As further components it is possible to add coatings additives, examples being flow control agents, and also stabilizers to counter UV light, such as triazoles and sterically hindered amines, to the formulas.

As already mentioned, the formulas of the invention can be used not only as hydrophilic, abrasion-resistant and/or scratch-resistant coatings, i.e., as protective coatings, but also as substrate layers for further coatings.

Typical layer thicknesses are situated in the range from 0.2 to 200 μm, preferably between 1 and 50 μm, very preferably between 2 and 20 μm.

Areas of application for the abrasion-resistant and scratch-resistant, highly transparent protective coatings are situated in areas in which glass is replaced by plastics, such as polycarbonate; for example, in the automobile segment, in architectural glazing, or in optical areas, such as spectacle lenses. In comparison to known, conventional scratch-resistant coatings, the hydrophilic hardcoat coatings of the invention may have two additional advantages. They exhibit, as described later on in the examples, “antifog” properties and also antistatic effects. “Antifog” properties can easily be detected by breathing on the surfaces in question: if the antifog properties are good, clouding as a result of air humidity is prevented.

The second major field of use of the hydrophilic hardcoat coatings of the invention is based on the fact that the surface is SiOH functional. This allows it to be recoated, or surface modified.

This surface modification may take place alternatively by physical methods, such as sputtering, for example, or chemical vapor deposition (CVD), by conventional coating methods, such as flowcoating, or by simple dipping operations, as for example from aqueous solutions. The latter method in particular, that of surface modification by dipping in aqueous formulas, is extremely simple. Thus, surprisingly, it has been found that, when the SiOH functional coatings of the invention are dipped into aqueous solutions of cationic compounds, they are able to bind cationic compounds very strongly. These cationic compounds may be either low molecular weight or high molecular weight compounds. Examples of low molecular weight, water-soluble cationic compounds are quaternary ammonium salts, examples being alkylbenzyldimethylammonium chloride in alcohol/water (Preventol R 80®), cationic or zwitterionic surfactants, examples being cetylpyridinium chloride or Phosphlipon® 90 G or cationic dyes, such as Methylenblau®. Examples of high molecular weight, water-soluble cationic compounds, which may be attached from aqueous phase to the silica-containing hardcoat coatings, are cationic polyelectrolytes, such as polyallyamine hydrochloride (PAH), polydiallyldimethylammonium chloride (PolyDADMAC), polyethylenimine hydrochloride or polyvinylamine hydrochloride. In this way it is possible for the surfaces of the hydrophilic hardcoat coatings of the invention to be modified in various directions, in accordance with the properties of the cationic compounds, by means of simple dipping and washing operations. Accordingly the silica-containing coating-material surfaces of the invention are ideally suited to the application of self-assembled polyelectrolyte multilayers, as described for example in Current Opinion in Colloid and Interface Science 8 (2003) 86-95.

The present invention further provides shaped articles having a surface coated with the composition of the invention or by the process of the invention.

The present invention additionally provides multilayer products comprising a substrate layer having at least on one side a second layer, this second layer being produced from a composition of the invention. The multilayer products may include a further layer of cationic or zwitterionic compounds.

### EXAMPLES

### Example 1

### Conversion of Alkali-Stabilized, Aqueous Silica Nanoparticles into the Alcohol-Compatible, SiOH Functional Modification

500.00 g of Levasil 300®/30% (aqueous, Na+ stabilized silica nanoparticle suspension, 30% by weight, 300 m²/g, pH 10, H. C. Starck, Germany) were admixed with 250 g of Lewatit S 100® (acidic cation exchanger in H form). The suspension was stirred for 1 h using a magnetic stirrer and then separated from the ion exchanger by filtration via a paper filter. The filtrate was admixed with 100.00 g of diacetone alcohol (DAA, 4-hydroxy-4-methyl-2-pentanone).

Using a rotary evaporator, water was distilled off at a subatmospheric pressure of approximately 15-20 mbar. When 300 ml of distillate had been obtained, a further 200.00 g of diacetone alcohol were added and concentration under vacuum was continued. The evaporation process was continued, with monitoring by an analysis for solids content, until a 30% by weight suspension in diacetone alcohol was obtained. The water content, determined by the Karl Fischer method, was 3.8% by weight.

### Example 2

### Preparation of a UV-Crosslinkable Acrylate Formulation Containing Silica Nanoparticles, with an Acrylate Mixture as Binder, and also DSSNa Surfactant

7.0 g of dipentaerythritol penta/hexaacrylate (DPHA), 1.5 g of pentaerythritol triacrylate (PETA), and 1.5 g of tripropylene glycol diacrylate (TPGDA) were stirred in a glass beaker in 48.0 g of diacetone alcohol (DAA) using a magnetic stirrer, a clear solution forming after a few minutes. This solution was admixed with 0.28 g of DSSNa, a clear solution being obtained on stirring. The UV initiator mixture consisting of 0.4 g of 1-hydroxycyclohexyl phenyl ketone (Irgacure 184®) and 0.1 g of diphenyl(2,4,6-trimethylbenzoyl)phosphine oxide) (Darocure TPO®) was added, and stirring was continued in the absence of light for a further 20 minutes, giving a clear solution.

Finally, 83.0 g of 30% by weight silica nanoparticle suspension in DAA, described in Ex. 1, were added. Stirring was continued in the absence of light for 15 minutes. The clear nanoparticle suspension was filtered into a brown bottle via a 3 μm paper filter. A solids content of 25.3% by weight was ascertained by means of a thermal balance.

### Example 3

### Coating of Polycarbonate Substrates

The suspension described in Ex. 2 was applied by flowcoating to polycarbonate substrates. This was done using two substrates with the area dimensions 10×15 cm:

Substrate 1: Makrolon® M 2808 (bisphenol A polycarbonate: medium-viscosity bisphenol A polycarbonate, MFR 10 g/10 min to ISO 1133 at 300° C. and 1.2 kg, without UV stabilization and mold release agent)
Substrate 2: Makrolon® Al 2647 (medium-viscosity bisphenol A polycarbonate with UV stabilizer and mold release agent; MFR 13 g/10 min to ISO1133 at 300° C. and 1.2 kg).

In addition, for comparison, the substrates were not coated and were subjected to the following measurement methods, as comparative tests.

For these purposes the substrates were first cleaned with isopropanol and blown dry with ionized air. The casting solution applied by flowcoating was flashed at room temperature (RT) for 5 minutes to start with and then dried at 80° C. for 30 minutes. Thereafter the coating was subjected to UV curing by means of an Hg lamp, the irradiated energy being approximately 5 J/cm².

Characterization of the dry film composition: in addition to the acrylate binder, there is 70% by weight of silica and 0.8% by weight of DSSNa.

The coatings were characterized by the following parameters:
a) Layer thickness by means of white light interferometer
   Top: 2.7 μm, Middle: 3.3 μm, Bottom: 4.2 μm
b) Haze by means of hazemeter to ASTM 1003-00 on Makrolon M 2808 substrate
   A haze value of 0.25% was found, corresponding to excellent transparency
c) Abrasion by means of abrasion wheel method to DIN 53 754 (Taber Test) on Makrolon M 2808 substrate
   After 1000 cycles a haze value of 9.71 was found.
d) Adhesion by tape test to ASTM D 3359-02 of Makrolon M 2808 and A12647 substrates

The cross-cut tape test showed completely smooth edges and accordingly was given an index of 0 in accordance with DIN EN ISO 2409. The coating therefore exhibits perfect adhesion to both substrates 1 and 2.
e) Water contact angle: The contact angle was determined by applying approximately 50 μl of water by pipette and visually estimating the corresponding angle between substrate surface and water drops. The contact angle with water allows the hydrophilicity to be estimated, with decreasing numerical values signifying increasing hydrophilicity.
   In the case of the coating-material surface of Ex. 3, a uniform flow of the water droplet with a very flat contact angle (approximately <)20° was found. In the case of the comparative test with the uncoated Makrolon® M 2808 substrate, in contrast, a value of approximately 90° was found.
“Antifog” properties: A substrate of which half was provided with the silica/acrylate coating layer of the invention was breathed on. The uncoated part clouded over and became opaque, whereas on the part with the hydrophilic protective layer there was no discernible change, i.e., the transparency was fully retained.

### Example 4

### Silica Nanoparticles in 1-methoxy-2-propanol (MOP)

500.0 g of Organosilicasol®IPA ST dispersion (10-15 nm silica nanoparticles, 30-31% by weight in isopropanol, pH 2-4, water content <1%, Nissan, Japan) were evaporated on a rotary evaporator at 20-30 mbar and 30-35° C., the isopropanol (IPA) distilled off being replaced by 1-methoxy-2-propanol (MOP). This operation was conducted so as to give, as the end product, a 30% by weight silica nanoparticle dispersion in 1-methoxy-2-propanol, referred to below as SiO² (MOP). This is a product similar to that of Ex. 1, differing only in terms of the solvent.

### Example 5

### Preparation of a UV-Crosslinkable Acrylate Formulation Containing Silica Nanoparticles, with DPHA as Binder and also DSSNa as Surfactant

10.00 g of dipentaerythritol hexaacrylate (DPHA, Aldrich) were dissolved in a 250 ml 3-necked flask with stirring in 24.60 g of MOP (from KMF). This solution was admixed with 0.14 g of the DSSNa surfactant and stirring was continued until a clear solution was obtained. The UV initiator mixture, consisting of 0.4 g of 1-hydroxycyclohexyl phenyl ketone (Irgacure 184® and 0.1 g of diphenyl(2,4,6-trimethylbenzoyl)phosphine oxide) (Darocure TPO® was added and stirring was continued in the absence of light for a further 20 minutes until a clear solution was obtained. Finally, 35.60 g of the dispersion SiO₂ (MOP) described in Ex. 4 were added and stirring was continued until a clear dispersion was formed which was filtered via a 3 μm paper filter. The dispersion was stored in dark bottles.

Characterization of the dry film material: in addition to the acrylate binder there is 50% by weight of silica and 0.7% by weight of DSSNa.

### Example 6

### (Comparative Example): Preparation of a UV-Crosslinkable Acrylate Formulation Containing Silica Nanoparticles, with DPHA as Binder, Without Surfactant

The casting solution was prepared in the same way as in Ex. 5, but with the amounts in g indicated in the table below.

Characterization of the dry film material: In addition to the arylate binder there is 50% by weight silica, but no surfactant.

### Example 7

### Comparison of Example 5 and Example 6 and Determination of the Coatings Properties

For comparison, the initial weights are recorded in the table:

| | Ex. 6 (amounts | Ex. 5 (amounts |
|---|---|---|
| Component | in grams) | in grams) |
| DPHA | 10.00 | 10.00 |
| Irgacure 184 | 0.40 | 0.400 |
| Darocure TPO | 0.10 | 0.10 |
| Silica sol in MOP (31%) | 35.10 | 35.60 |
| SiO₂ (MOP) from Ex.4 | | |
| MOP | 24.40 | 24.60 |
| DSSNa | 0.00 | 0.14 |
| Total amount | 70.00 | 70.84 |

The formulations described were coated onto the substrates 1 and 2 as in Example 3.

The coated substrate obtained with the casting solution according to Example 5 is referred to below as Example 5-1; the coated substrate obtained with the casting solution of Example 6 is referred to as Example 6-1.

The properties of Examples 5-1 and 6-1 were determined with reference to the measurement methods described in Example 3:

Layer thickness: In both cases about 2.5 to 5.0 μm.
Adhesion: The test is carried out in accordance with ASTM D 3359: Tape test after cross-cut. Assessment is in accordance with DIN EN ISO 2409. An ISO index of 0 means that the cut edges are completely smooth, and no section of the coating has undergone delamination. In all cases values of 0 (according to DIN 2409) were found.
Antifog: In Example 5-1 only minimal clouding, and in Example 6-1 only slight clouding, were found.

### Water Contact Angle and Abrasion (Δ Haze % 1000)

| | Haze (%) | Δ Haze 1000 (%) | Contact angle |
|---|---|---|---|
| Example 5-1 | | | |
| 50% by weight silica | 0.53 | 7.42 | Very shallow, |
| 0.7% by weight | | | about 20-25° |
| DSSNa | | | |
| Example 6-1 | | | |
| 50% by weight silica | 0.45 | 18.81 | Shallow, about 40° |
| 0.0 by weight DSSNa | | | |

The abrasion properties were determined by comparing the haze values of the original sample with the haze after an abrasion test of 1000 cycles.

Haze: In accordance with ASTM 1003-00 by means of hazemeter, as measure of the transparency

Δ Haze 1000 c: Haze value after 1000 cycles of Taber test minus haze value of the original sample. The Taber test takes place in accordance with DIN 53 754 by the abrasion wheel method with the model 5151 abraser (CS-10F Calibrase abrading wheels with 500 g weights per wheel).

As the values show, the addition of surfactant includes not only the abrasion but also the wettability with water.

### Examples 8 and 9

### Preparation of a UV-Crosslinkable Acrylate Formulation Containing Silica Nanoparticles, with DPHA as Binder, with and without Surfactant

The coating formulas were produced as per Example 5 on the basis of the following initial masses in g:

| | | Ex. 9 (Ex. 8 without |
|---|---|---|
| Component | Ex. 8 with surfactant | surfactant) |
| DPHA | 10.00 | 10.00 |
| Irgacure 184 | 0.40 | 0.40 |
| Darocure TPO | 0.10 | 0.10 |
| Silica sol in MOP (31%) | 70.60 | 69.20 |
| SiO₂ (MOP) from Ex. 4 | | |
| MOP | 20.80 | 20.20 |
| DSSNa | 0.20 | 0.00 |
| Total amount | 102.10 | 99.90 |

Application of the coating material took place to substrate 1 as per Ex. 7. The coated substrates obtained are called Example 8-1 and 9-1.

Characterization of the dry film material: In addition to the acrylate binder there is 65% by weight of silica with and without surfactant.

The properties of Examples 8-1 and 9-1 were determined in accordance with the measurement methods described in Example 1

Antifog properties: In both cases there was no observable hazing on breathing.
Adhesion: In the adhesion test, values of 0 (in accordance with DIN 2409) were determined in all cases.
Haze and Contact Angle with Water:

| | Haze (%) | Δ Haze 1000 (%) | Contact angle |
|---|---|---|---|
| Example 8-1 | | | |
| 65% by weight silica, | 0.28 | 6.6 | Very shallow, |
| based on dry film mass | | | about <20° |
| 0.7 by weight DSSNa | | | |
| Example 9-1 | | | |
| 65% by weight silica, | 0.38 | 18.11 | Shallow, |
| based on dry film mass | | | about <40° |
| 0.0 by weight DSSNa | | | |

As shown by Examples 8-1 and 9-2, the addition of DSSNa had a beneficial influence not only on the abrasion (small Δ haze 1000 values) but also on the hydrophilicity (shallow contact angles with water).

### Example 10

### Coloring the Coating with a Cationic Dye

Example 8-1 was immersed into a 0.1% strength by weight aqueous solution of methylene blue (cationic dye) and washed off with water. A uniform, intense blue coloration was found on the side coated with coating material.

In a comparative experiment the same substrate was immersed into a 0.1% strength by weight solution of erioglaucin (anionic dye) and washed off with water, there being no staining whatsoever.

This comparison shows that the silica-containing coating-material surfaces of the invention exhibit a high, selective affinity for cationic agents.

### Example 11

### Modification of the Coating with a Quaternary Ammonium Salt

Part of the coating from Example 8-1 was immersed into a 1% strength by weight solution of alkyl-benzyldimethylammonium chloride (Preventol® R 50) in water and was rinsed off with water. The sample was dried (10 minutes in a forced-air drying cabinet at 50° C.) and subsequently a drop of water was applied to the part of the coating-material surface that had been modified with alkyl-benzyldimethylammonium chloride, revealing a very steep contact angle of approximately 90°. In contrast, the part of the coating-material surface that had not been modified with alkylbenzyl-dimethylammonium chloride had a very shallow contact angle (approximately <25°) with water.

The part of the coating-material surface that had been modified with alkylbenzyl-dimethylammonium chloride was exposed to a one-hour boiling test, and again subjected to a water contact angle test. As before the boiling test, a steep contact angle was observed. The quaternary ammonium compound had accordingly been attached to a high level/very strongly to the silica coating-material surface.

### Example 12

### Modification of the Coating with a Cationic Polyelectrolyte

The coating from Example 8-1 was immersed in water for 10 minutes in a 0.1% strength by weight solution of polyallylamine hydrochloride (PAH) in water. It was subsequently washed with water and dried.

The contact angle measurement with water (approximately)90° showed that the cationic polymer was attached to the coating-material surface. Even after extractive boiling for one hour, the contact angle remained unchanged, which suggests a very stable bond of the cationic polyelectrolyte to the silica-containing coating-material surface.

1-15. (canceled)

16. A composition comprising
a) colloidal silica;
b) an acrylate;
c) a protic solvent;
d) a UV initiator system; and
e) an anionic, sulfur-containing surfactant.

17. The composition of claim 16, wherein said acrylate is selected from the group consisting of monomeric acrylic esters, methacrylic esters, and mixtures thereof.

18. The composition of claim 17, wherein said acrylate is selected from the group consisting of trifunctional acrylate compounds, tetrafunctional acrylate compounds, hexafunctional acrylate compounds, trifunctional methacrylate compounds, tetrafunctional methacrylate compounds, hexafunctional methacrylate compounds, and mixtures thereof.

19. The composition of claim 16, wherein said anionic, sulfur-containing surfactant is dioctylsulfosuccinate sodium salt.

20. The composition of claim 16, wherein the % by weight content of said collidal silica is higher than the % by weight content of said acrylate.

21. The composition of claim 16, wherein the ratio of the parts by weight of said acrylate and said colloidal silica is in the range of from 25:75 to 45:55 acrylate:silica.

22. The composition of claim 16, wherein
a) said colloidal silica is a protonated, alcohol-compatible, spherical silicon dioxide nanoparticles having a pH of from 2 to 4 and a diameter of less than 30 nm;
b) said acrylate is a UV or electron beam crosslinkable, ethylenically unsaturated, low molecular mass acrylate or methacrylate having less than 30 C atoms and comprises an aliphatic or cycloaliphatic radical;
c) said protic solvent is an aliphatic alcohol;
d) said UV initiator system is a hydroxycyclohexyl phenyl ketone or diphenyl(2,4,6-trimethylbenzoyl)phosphine oxide; and
e) said anionic, sulfur-containing surfactant is dioctylsulfosuccinate sodium salt.

23. A process for preparing the composition of claim 16, comprising
i) preparing a suspension comprising said colloidal silica a);
ii) mixing said acrylate b), said UV initiator system d), said protic solvent c), and said surfactant e) in the absence of light; and
iii) mixing said suspension from i) and said mixture from ii) in the absence of light.

24. The process of claim 23, wherein suspension i) comprises from 5 to 80% by weight of said colloidal silica and said mixture ii) comprises from 5 to 60% by weight of said acrylate, from 0.01 to 0.8% by weight of said anionic, sulfur-containing surfactant, and from 0.1 to 10% by weight of said UV initiator system in said protic solvent.

25. A surface coated with the composition of claim 16.

26. A method of coating a surface comprising applying the composition of claim 16 to a surface and irradiating said composition applied to said surface with UV light.

27. A shaped article comprising a surface coated with the composition of claim 16.

28. A shaped article comprising a surface coated by the method of claim 26.

29. A shaped article comprising a surface coating comprising a colloidal silica, a crosslinked acrylate, a UV initiator, and an anionic, sulfur-containing surfactant.

30. A multilayer product comprising a substrate layer, wherein said substrate layer comprises on at least one side a second layer produced from composition of claim 16.

31. The multilayer product of claim 29, wherein said substrate layer comprises ceramic, marble, wood, a thermoplastic polymer, or glass.
